(19) United States
(12) Patent Application Publication
(10) Pub. No.: US 2017/0062116 A1
(43) Pub. Date: Mar. 2, 2017

(54) COIL ELECTRONIC COMPONENT AND METHOD OF MANUFACTURING THE SAME

(71) Applicant: SAMSUNG ELECTRO-MECHANICS CO., LTD., Suwon-si (KR)

(72) Inventors: Byung Soo KANG, Suwon-si (KR); Eo Jin CHOI, Suwon-si (KR); Eun Jin KIM, Suwon-si (KR)

(21) Appl. No.: 15/089,034

(22) Filed: Apr. 1, 2016

(30) Foreign Application Priority Data
Aug. 24, 2015 (KR) 10-2015-0118728

(51) Int. Cl. H01F 27/25; H01F 41/02; H01F 41/071; H01F 27/28

(52) U.S. Cl. CPC H01F 27/25; H01F 27/2823; H01F 41/0246; H01F 41/071; H01F 41/0213; H01F 41/0233

(57) ABSTRACT

A coil electronic component includes a magnetic body having a core part and a coil wound around the core part. The core part includes mixtures of magnetic metal material and resin. The magnetic body includes a first region adjacent to the coil and a second region adjacent to an outer surface of the magnetic body. Additionally, magnetic metal material of the first region adjacent to the coil has magnetic permeability higher than that of magnetic metal material of the second region adjacent to the outer surface of the magnetic body.

### CROSS-REFERENCE TO RELATED APPLICATION

This application claims the priority and benefit of Korean Patent Application No. 10-2015-0118728, filed on Aug. 24, 2015 with the Korean Intellectual Property Office, the disclosure of which is incorporated herein by reference.

### BACKGROUND

The present disclosure relates to a coil electronic component and a method of manufacturing the same.

An inductor, such as a coil electronic component, is a passive element that is commonly used in electronic circuits together with a resistor and a capacitor to remove noise.

The inductor may be manufactured by forming a coil, hardening magnetic powder-resin mixtures in which magnetic powders and resins are mixed with each other to manufacture a magnetic body enclosing the coil, and forming external electrodes on outer surfaces of the magnetic body.

As part of manufacturing an inductor according to the related art, manufacturing methods include steps for externally exposing end portions of the coil using a mold and connecting the exposed end portions of the coil and the external electrodes to each other.

However, the methods of manufacturing inductors according to the related art have limitations that impede the production of miniaturized inductors having high magnetic permeability. Specifically, the limitations are due to constraints imposed by the magnetic material enclosing the coil and the magnetic material provided in a core part of the coil.

### SUMMARY

An aspect of the present disclosure may provide a coil electronic component capable of implementing high magnetic permeability by allowing magnetic metal material of a core part and magnetic metal material of a region adjacent to a coil and a region adjacent to an outer surface of a magnetic body to have different characteristics.

According to an aspect of the present disclosure, a coil electronic component may include a magnetic body including a core part and a coil wound around the core part. The core part may include mixtures of magnetic metal material and resin, the magnetic body may include a first region adjacent to the coil and a second region adjacent to an outer surface of the magnetic body, and magnetic metal material of the first region adjacent to the coil may have magnetic permeability higher than that of magnetic metal material of the second region adjacent to the outer surface of the magnetic body.

According to another aspect of the present disclosure, a method of manufacturing a coil electronic component may include injecting mixtures of magnetic metal material and resin into a metal mold and pressing and molding the mixtures to prepare a core part. A coil is disposed around the core part, and a magnetic body is manufactured by enclosing the core part around which the coil is disposed with magnetic material containing magnetic metal material. The magnetic body may include a first region adjacent to the coil and a second region adjacent to an outer surface of the magnetic body, and magnetic metal material of the first region adjacent to the coil may have magnetic permeability higher than that of magnetic metal material of the second region adjacent to the outer surface of the magnetic body.

According to a further aspect of the present disclosure, a method of manufacturing a coil electronic component may include forming a magnetic body enclosing a core part around which a coil is wound using magnetic material containing magnetic metal material. The magnetic body may have a first region adjacent to the coil and a second region adjacent to an outer surface of the magnetic body, and magnetic metal material of the first region adjacent to the coil may have magnetic permeability higher than that of magnetic metal material of the second region adjacent to the outer surface of the magnetic body.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a perspective view illustrating a coil electronic component according to an exemplary embodiment;

FIG. 2 is a cross-sectional view taken along line I-I′ of FIG. 1;

FIGS. 3A through 3D are views illustrating sequential steps of a method of manufacturing a coil electronic component according to a first exemplary embodiment;

FIGS. 4A through 4D are views illustrating sequential steps of a method of manufacturing a coil electronic component according to a second exemplary embodiment;

FIGS. 5A through 5D are views illustrating sequential steps of a method of manufacturing a coil electronic component according to a third exemplary embodiment; and

FIGS. 6A through 6E are views illustrating sequential steps of a method of manufacturing a coil electronic component according to a fourth exemplary embodiment.

### DETAILED DESCRIPTION

Hereinafter, embodiments of the present inventive concepts will be described as follows with reference to the attached drawings.

The present inventive concepts may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another member, component, region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's positional relationship to another element (s) as shown in the orientation shown in the figures. It will be understood that the spatially relative positional terms are intended to encompass different orientations of the device in use or operation in addition to the orientation depicted in the figures. For example, if the device in the figures is turned over, elements described as “above,” or “upper” relative to other elements would then be oriented “below,” or “lower” relative to the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein is for describing particular embodiments only and is not intended to be limiting of the present inventive concepts. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups, but do not preclude the presence or addition of one or more other features, integers, steps, operations, members, elements, and/or groups.

Hereinafter, embodiments of the present inventive concept will be described with reference to schematic views illustrating embodiments of the present inventive concepts. In the drawings, for example due to manufacturing techniques and/or tolerances, modifications of the shapes shown may be estimated. Thus, embodiments of the present inventive concepts should not be construed as being limited to the particular shapes of regions shown herein, but should more generally be interpreted as including, for example, a change in shape resulting from manufacturing processes. The following embodiments may also be constituted by one or a combination thereof.

The contents of the present inventive concepts described below may have a variety of configurations, and only illustrative configurations are shown and described herein. The inventive concepts should not be interpreted as being limited to those illustrative configurations.

Coil Electronic Component

Hereinafter, a coil electronic component according to an exemplary embodiment will be described. The exemplary embodiment may include a power inductor. However, the coil electronic component according to an exemplary embodiment is not limited thereto.

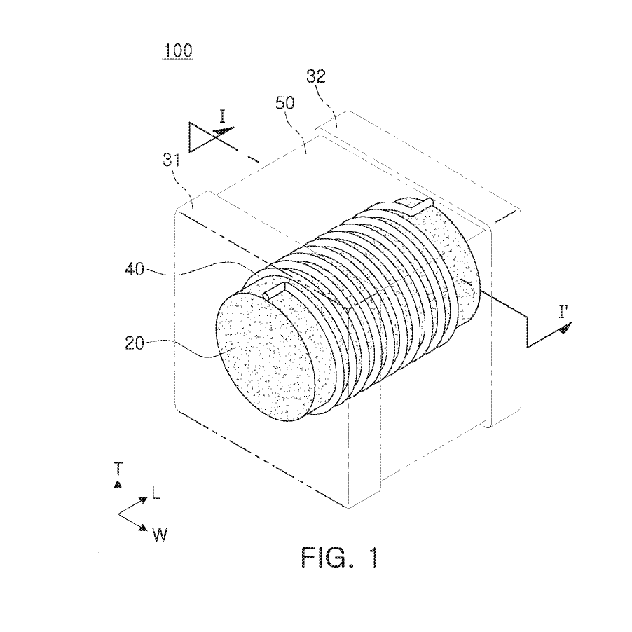

FIG. 1 is a perspective view illustrating a coil electronic component according to an exemplary embodiment. Portions of the coil electronic component of FIG. 1 are shown as translucent so that a coil of the coil electronic component is visible.

Referring to FIG. 1, a power inductor used in a power line of a power supply circuit is disclosed as an example of the coil electronic component.

A coil electronic component 100 according to an exemplary embodiment may include a magnetic body 50 including a core part 20 and a coil 40 wound around the core part 20, and first and second external electrodes 31 and 32 disposed on outer surfaces of the magnetic body 50 and contacting the coil 40.

In the coil electronic component 100 according to an exemplary embodiment, a ‘length’ direction refers to an direction of FIG. 1, a ‘width’ direction refers to a ‘W’ direction of FIG. 1, and a ‘thickness’ direction refers to a ‘T’ direction of FIG. 1.

The coil 40 may be fitted onto the core part 20 such that it is wound in a winding form, but is not limited thereto.

For example, the coil 40 may be wound by rectangular copper wire heat fusion, and a form of the wound coil 40 may be maintained by shape forming.

The coil 40 may have a solenoid shape.

The coil 40 may be formed of a metal having excellent electrical conductivity, such as silver (Ag), palladium (Pd), aluminum (Al), nickel (Ni), titanium (Ti), gold (Au), copper (Cu), platinum (Pt), or alloys thereof.

The coil 40 may be coated with an insulating film (not illustrated), and thus the coil 40 may not directly contact magnetic material forming the magnetic body 50.

The magnetic body 50 enclosing the coil 40 may contain any magnetic material that shows magnetic properties. For example, the magnetic body 50 may contain ferrite or magnetic metal powders.

The higher the magnetic permeability of the magnetic material contained in the magnetic body 50, and the larger the area of the magnetic body 50 through which a magnetic flux passes, the higher the inductance (L) of the coil electronic component 100.

One end portion of the coil 40 may be extended to thereby be exposed to one end surface of the magnetic body 50 in the length direction, and the other end portion of the coil 40 may be extended to thereby be exposed to the other end surface of the magnetic body 50 in the length direction.

However, the coil 40 is not limited thereto, and may additionally or alternatively be exposed to at least one other surface of the magnetic body 50.

The first and second external electrodes 31 and 32 may be formed on the outer surfaces of the magnetic body 50 to each be connected to a respective end portion of the coil 40 exposed to an end surface of the magnetic body 50 in the length direction.

The first and second external electrodes 31 and 32 may be formed of a metal having excellent electrical conductivity, such as copper (Cu), silver (Ag), nickel (Ni), tin (Sn), or the like, or alloys thereof.

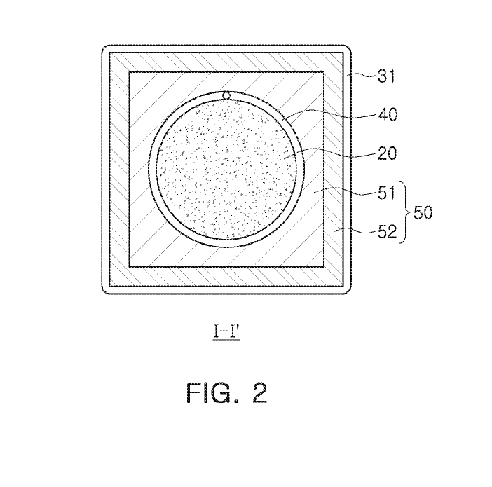

FIG. 2 is a cross-sectional view taken along line I-I′ of FIG. 1.

Referring to FIG. 2, the core part 20 may contain mixtures of metal magnetic material and resin, the magnetic body 50 may be divided into a region 51 adjacent to the coil 40 and a region 52 adjacent to an outer surface of the magnetic body 50, and magnetic metal material of the region 51 adjacent to the coil 40 may have magnetic permeability higher than that of magnetic metal material of the region 52 adjacent to the outer surface of the magnetic body 50.

Since the core part 20 is filled with the magnetic material, an area of magnetic material through which a magnetic flux passes may be increased to improve inductance (L).

That is, in the coil electronic component, a packing factor of the magnetic material provided in the core part may have a correlation to the inductance (L).

In a method of manufacturing an inductor according to the related art, there is a limitation in increasing a packing factor of the magnetic material enclosing the core part in the coil and the coil, and thus there is a limitation in increasing inductance of the coil electronic component.

According to an exemplary embodiment, the core part 20 may contain mixtures of the magnetic metal material and the resin. The mixtures of the magnetic metal material and the resin may be injected into, pressed, and molded in a metal mold, whereby a packing factor of the magnetic material in the core part 20 may be significantly increased.

Since the packing factor of the magnetic material in the core part 20 as described in the preceding paragraph is much higher than that obtained by embedding a coil in a mold into which a slurry containing magnetic material is injected and performing room temperature compression, high temperature compression, and the like (as in the method of manufacturing an inductor according to the related art), high inductance of the coil electronic component may be implemented.

Meanwhile, the core part 20 may contain the magnetic metal material and the resin.

The resin is not particularly limited, but may be, for example, a crystalline epoxy resin.

The magnetic metal material may be a metal containing one or more selected from the group consisting of iron (Fe), silicon (Si), boron (B), phosphor (P), chrome (Cr), copper (Cu), niobium (Nb), and nickel (Ni), or alloys thereof, and may be a crystalline or amorphous metal.

For example, the magnetic metal material may be an Fe—Si—B—P—Cr based or Fe—Si—B—Nb—Cu based amorphous metal, but is not limited thereto.

The magnetic metal material contained in the core part 20, which is a high magnetic permeability material, may be a metal containing a crystalline iron (Fe)-silicon (Si) based material, or an alloy thereof.

In a case in which the magnetic metal material contained in the core part 20 is the crystalline metal containing the iron (Fe)-silicon (Si) based material, high magnetic permeability and high direct current (DC) bias characteristics may be implemented.

The magnetic metal material contained in the core part 20 may have a string shape.

The string shape is not particularly limited, but may be, for example, a flake shape.

In a case in which the magnetic metal material contained in the core part 20 has the string shape, a coil electronic component having high internal magnetic permeability and low loss may be implemented.

In addition, in the case in which the magnetic metal material has the string shape, one axis thereof may be disposed in parallel with a direction of magnetic flux. Therefore, a direction of magnetic permeability of the magnetic metal material may be adjusted to coincide with the direction of the magnetic flux.

In addition, the magnetic metal material contained in the core part 20 may have a saturation magnetic flux larger than that of the magnetic metal material of the region 51 adjacent to the coil 40.

In addition, the magnetic metal material contained in the core part 20 may have a saturation magnetic flux larger than that of the magnetic metal material of the region 52 adjacent to the surface of the magnetic body.

In the case in which the magnetic metal material contained in the core part 20 is the crystalline metal containing the iron (Fe)-silicon (Si) based material, an excellent quality (Q) factor, excellent DC bias characteristics, and the like, may be implemented by a high saturation magnetic flux.

Referring to FIG. 2, the magnetic body 50 may be divided into the region 51 adjacent to the coil 40 and the region 52 adjacent to the outer surface of the magnetic body 50. The magnetic metal material of the region 51 adjacent to the coil 40 may have magnetic permeability higher than that of the magnetic metal material of the region 52 adjacent to the outer surface of the magnetic body 50.

The magnetic metal material of the region 51 adjacent to the coil 40 may have the magnetic permeability higher than that of the metal magnetic material of the region 52 adjacent to the outer surface of the magnetic body 50, whereby high magnetic permeability of the coil electronic component 100 may be implemented, and other electrical characteristics of the coil electronic component 100 (inductor) may be excellent.

A method of forming the magnetic metal material of the region 51 adjacent to the coil 40 to have the magnetic permeability higher than that of the magnetic metal material of the region 52 adjacent to the outer surface of the magnetic body 50 is not particularly limited. The method may be performed by manufacturing magnetic material enclosing the core part 20 and containing magnetic metal material in a sheet shape, inserting the magnetic material having the sheet shape into the region 51 adjacent to the coil 40 and the region 52 adjacent to the outer surface, and then pressing and molding the magnetic material having the sheet shape, as described below.

That is, a method of allowing the magnetic metal material of the region 51 adjacent to the coil and the region 52 adjacent to the outer surface of the magnetic body 50 to have different characteristics may be performed by separately manufacturing magnetic metal material having different characteristics in sheet shapes. The magnetic metal material having the sheet shape is then inserted into the region 51 adjacent to the coil 40 and the region 52 adjacent to the outer surface, and then the magnetic metal material having the sheet shape is molded to form a magnetic body 50.

Method of Manufacturing Coil Electronic Component

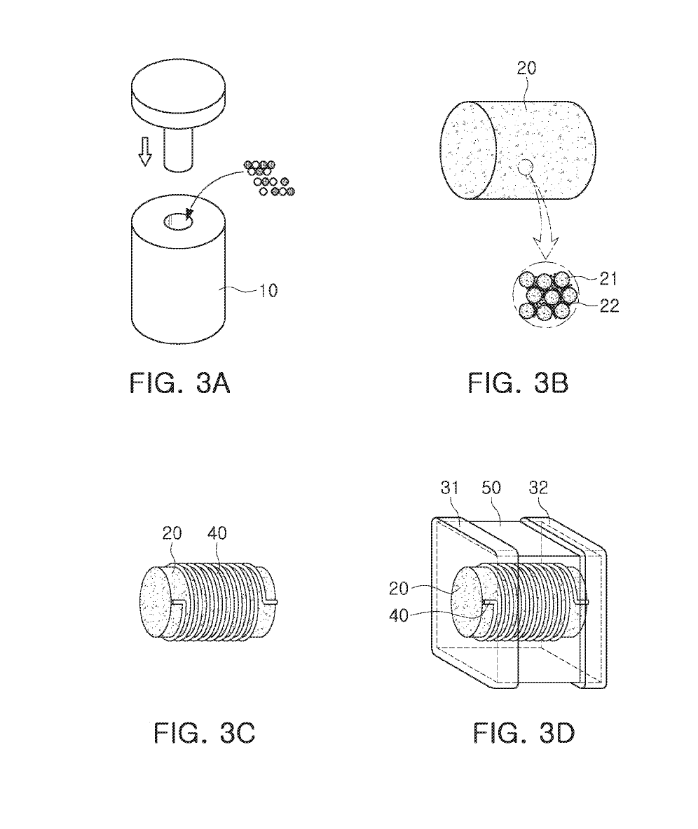

FIGS. 3A through 3D are views illustrating sequential steps of a method of manufacturing a coil electronic component according to a first exemplary embodiment.

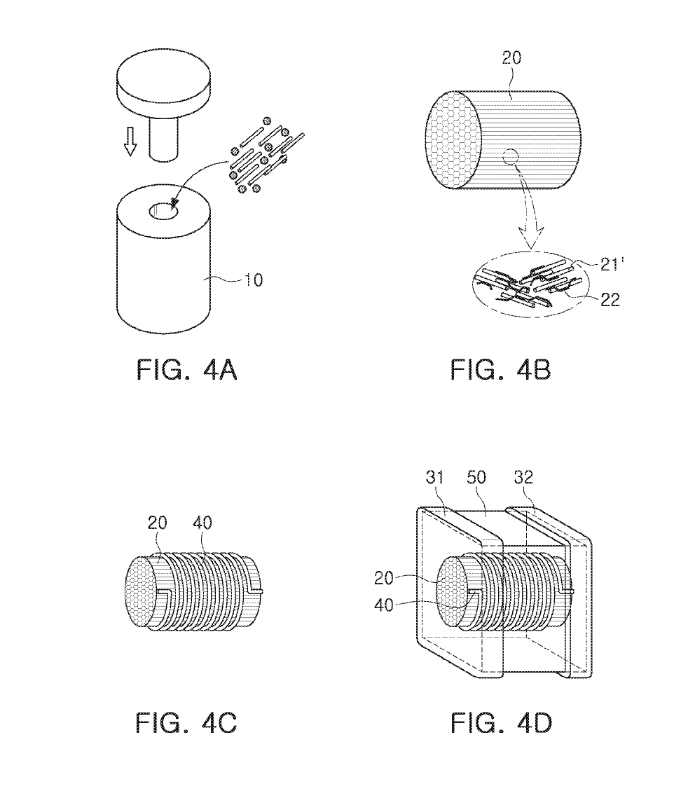

FIGS. 4A through 4D are views illustrating sequential steps of a method of manufacturing a coil electronic component according to a second exemplary embodiment.

Referring to FIGS. 3A through 3D, the method of manufacturing a coil electronic component according to a first exemplary embodiment may include: injecting mixtures of magnetic metal material 21 and resin 22 into a metal mold 10 and pressing and molding the mixtures to prepare the core part 20; loading, forming, winding, or disposing the coil 40 around the core part 20; and manufacturing the magnetic body 50 by enclosing the core part 20 around which the coil 40 is wound with magnetic material containing magnetic metal material. The magnetic body 50 may be divided into the region 51 adjacent to the coil 40 and the region 52 adjacent to the outer surface of the magnetic body 50, and a magnetic metal material of the region 51 adjacent to the coil 40 may be manufactured to have magnetic permeability higher than that of magnetic metal material of the region 52 adjacent to the outer surface of the magnetic body 50.

Referring to FIGS. 3A through 3D, the mixtures of the magnetic metal material 21, which is a high magnetic permeability material, and the crystalline epoxy resin 22 may be injected into and be then pressed and molded in the metal mold 10 to prepare the core part 20.

High magnetic permeability magnetic material may be used as the magnetic metal material 21.

Alternatively, as illustrated in FIGS. 4A through 4D, in a coil electronic component according to a second exemplary embodiment, magnetic metal material 21′ may have a string shape. In this case, as shown in FIGS. 4A and 4B, the mixtures of the magnetic metal material 21′, which has a string shape, and the crystalline epoxy resin 22 may be injected into and be then pressed and molded in the metal mold 10 to prepare the core part 20.

Next, the coil 40 may be loaded around the core part 20.

The coil 40 may be formed of a conductive metal having excellent electrical conductivity, such as silver (Ag), palladium (Pd), aluminum (Al), nickel (Ni), titanium (Ti), gold (Au), copper (Cu), platinum (Pt), or alloys thereof.

The coil 40 may be loaded by winding the coil 40 by rectangular copper wire heat fusion, forming the coil 40 in a solenoid shape, and then inserting the coil 40 onto the core part 20 loaded on a substrate, but is not limited thereto.

Finally, the magnetic body 50 may be manufactured by enclosing the core part 20 around which the coil 40 is loaded with the magnetic material containing the magnetic metal material, and the external electrodes 31 and 32 may be formed on both end surfaces of the magnetic body 50 to manufacture the coil electronic component 100.

In the manufacturing of the magnetic body 50 by enclosing the core part 20 around which the coil 40 is loaded with the magnetic material containing the magnetic metal material, the magnetic body 50 may be divided into the region 51 adjacent to the coil 40 and the region 52 adjacent to the outer surface of the magnetic body 50, and the magnetic metal material of the region 51 adjacent to the coil 40 may be manufactured to have the magnetic permeability higher than that of metal magnetic material of the region 52 adjacent to the outer surface of the magnetic body 50.

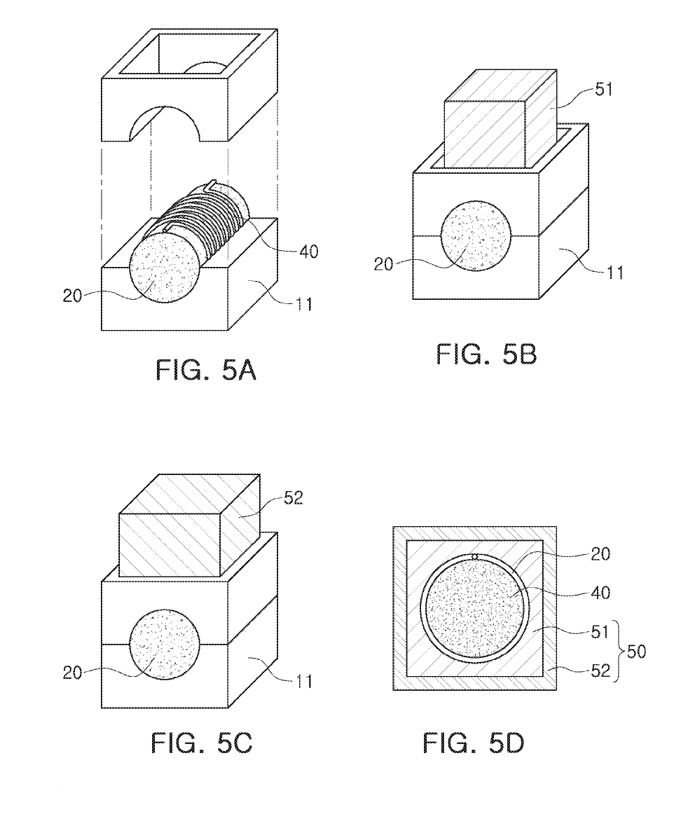

FIGS. 5A through 5D are views illustrating sequential steps of a method of manufacturing a coil electronic component 100 according to a third exemplary embodiment.

Referring to FIGS. 5A through 5D, in the manufacturing of the magnetic body 50 by enclosing the core part 20 around which the coil 40 is loaded with the magnetic material containing the magnetic metal material, the magnetic material enclosing the core part 20 and containing the magnetic metal material may have a sheet shape.

As described above, since the magnetic material enclosing the core part 20 and containing the magnetic metal material has the sheet shape, the magnetic metal material of the region 51 adjacent to the coil 40 may be manufactured to have the magnetic permeability higher than that of the magnetic metal material of the region 52 adjacent to the outer surface of the magnetic body 50.

In more detail, the manufacturing of the magnetic body 50 may include inserting and fixing the core part 20 around which the coil 40 is loaded into a mold 11 separated in a vertical direction, inserting magnetic sheets for forming the region 51 adjacent to the coil 40 in the magnetic body 50 into the region 51 adjacent to the coil 40 and then pressing and molding the magnetic sheets for forming the region 51 adjacent to the coil 40. In turn, magnetic sheets for forming the region 52 adjacent to the outer surface of the magnetic body 50 are inserted into the region 52 adjacent to the outer surface, and the magnetic sheets are pressed and molded for forming the region 52 adjacent to the outer surface.

That is, in the manufacturing of the magnetic body 50, first, the core part 20 around which the coil 40 is loaded may be inserted and fixed into the mold 11 separated in the vertical direction.

Next, the magnetic sheets for forming the region 51 adjacent to the coil 40 in the magnetic body 50 may be inserted into the region 51 adjacent to the coil 40 and then pressed and molded.

Next, the magnetic sheets for forming the region 52 adjacent to the outer surface of the magnetic body 50 may be inserted into the region 52 adjacent to the outer surface and then pressed and molded to manufacture the magnetic body 50.

Here, the magnetic sheets for forming the region 51 adjacent to the coil 40 may contain material having magnetic permeability higher than that of material contained in the magnetic sheets for forming the region 52 adjacent to the outer surface of the magnetic body 50.

Meanwhile, the magnetic sheets for forming the region 52 adjacent to the outer surface of the magnetic body 50 may contain material having an insulation property higher than that of material contained in the magnetic sheets used for forming the region 51 adjacent to the coil 40. For example, the material having the higher insulating property may have a higher electrical resistance, a lower electrical conductivity, or the like.

In addition, magnetic metal material contained in the magnetic sheets for forming the region 52 adjacent to the outer surface of the magnetic body 50 may be material having an insulation property higher than that of the magnetic metal material contained in the core part 20.

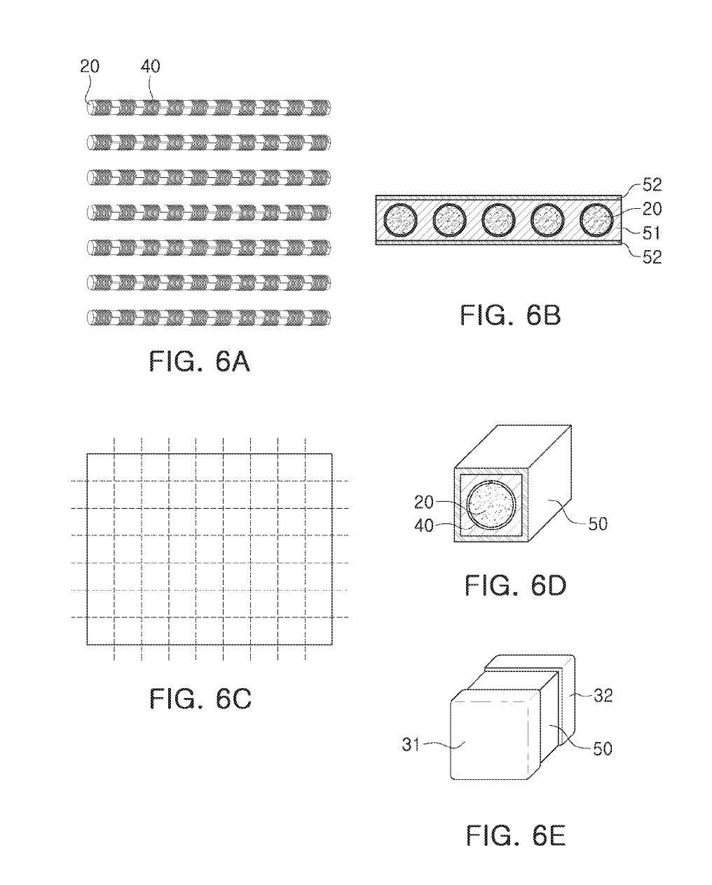

FIGS. 6A through 6E are views illustrating sequential steps of a method of manufacturing a coil electronic component according to a fourth exemplary embodiment.

Referring to FIGS. 6A through 6E, the core part 20 around which the coil 40 is loaded may be formed by loading a plurality of coils around a cylindrical core part structure and then cutting each coil and core part depending on a size of the core part.

In detail, the coil electronic component according to a fourth exemplary embodiment may be manufactured by loading the plurality of coils 40 around the cylindrical structure core part, compressing metal magnetic sheets 51 and 52 on top and beneath the cylindrical structure around which the plurality of coils 40 are loaded, and then cutting the resulting structure having the cylindrical structure on top and beneath which the metal magnetic sheets 51 and 52 are compressed.

Here, each cut part of the cylindrical structure core part may be formed as an individual core part 20.

Sheets containing magnetic metal material may be disposed appropriately in order to provide magnetic material in the core part 20 and in the vicinity of the coil 40 wound around the core part 20, and may be stacked, compressed, and hardened to form the magnetic body 50 enclosing the core part 20 and the coil 40.

The sheets may be separately manufactured as the magnetic sheets for forming the region 51 adjacent to the coil 40 and the magnetic sheets for forming the region 52 adjacent to the outer surface of the magnetic body 50.

The magnetic body 50 may be formed by inserting the magnetic sheets for forming the region 51 adjacent to the coil 40 in the magnetic body 50 into the region 51 adjacent to the coil 40 and then pressing and molding the magnetic sheets for forming the region 51 adjacent to the coil 40. In turn, the magnetic sheets for forming the region 52 adjacent to the outer surface of the magnetic body 50 are inserted into the region 52 adjacent to the outer surface, and the magnetic sheets are pressed and molded for forming the region 52 adjacent to the outer surface.

The sheets may be separately manufactured in a form in which magnetic metal material having different characteristics are dispersed in thermosetting resins such as epoxy resins, polyimide resins, or the like.

Next, the first and second external electrodes 31 and 32 may be formed on the outer surfaces of the magnetic body 50 so as to be connected to respective end portions of the coil 40.

A description of features overlapping those of the coil electronic component 100 according to the various exemplary embodiments described above except for the above-mentioned description will be omitted.

As set forth above, according to an exemplary embodiment, the magnetic metal material of the core part 20 and the magnetic metal material of the region 51 adjacent to the coil 40 and the region 52 adjacent to the outer surface of the magnetic body 50 may have different characteristics, and thus high magnetic permeability, high DC bias characteristics, and a high packing factor are implemented, whereby an inductor having high inductance may be implemented.

While exemplary embodiments have been shown and described above, it will be apparent to those skilled in the art that modifications and variations could be made without departing from the scope of the present invention as defined by the appended claims.

What is claimed is:

1. A coil electronic component comprising:
a magnetic body including a core part and a coil wound around the core part,
wherein the core part includes mixtures of magnetic metal material and resin, the magnetic body includes a first region adjacent to the coil and a second region adjacent to an outer surface of the magnetic body, and magnetic metal material of the first region adjacent to the coil has a magnetic permeability higher than that of magnetic metal material of the second region adjacent to the outer surface of the magnetic body.

2. The coil electronic component of claim 1, wherein the magnetic metal material included in the core part has a string shape.

3. The coil electronic component of claim 1, wherein the magnetic metal material included in the core part has a saturation magnetic flux larger than that of the magnetic metal material of the first region adjacent to the coil.

4. The coil electronic component of claim 1, wherein the resin is a crystalline epoxy resin.

5. The coil electronic component of claim 1, wherein the magnetic metal material included in the core part is a metal containing a crystalline iron (Fe)-silicon (Si) based material, or an alloy thereof.

6. A method of manufacturing a coil electronic component, comprising:
injecting mixtures of magnetic metal material and resin into a metal mold and pressing and molding the mixtures to prepare a core part;
disposing a coil around the core part; and
manufacturing a magnetic body by enclosing the core part around which the coil is disposed with magnetic material containing magnetic metal material,
wherein the magnetic body includes a first region adjacent to the coil and a second region adjacent to an outer surface of the magnetic body, and magnetic metal material of the first region adjacent to the coil has magnetic permeability higher than that of magnetic metal material of the second region adjacent to the outer surface of the magnetic body.

7. The method of claim 6, wherein the magnetic metal material included in the core part has a string shape.

8. The method of claim 6, wherein in the manufacturing of the magnetic body, the magnetic material enclosing the core part and containing the magnetic metal material has a sheet shape.

9. The method of claim 8, wherein the manufacturing of the magnetic body includes:
inserting and fixing the core part around which the coil is disposed into a mold separated in a vertical direction;
inserting magnetic sheets for forming the first region adjacent to the coil in the magnetic body into an area adjacent to the coil and then pressing and molding the magnetic sheets to form the first region adjacent to the coil; and
inserting magnetic sheets for forming the second region adjacent to the outer surface of the magnetic body into an area adjacent to the outer surface and then pressing and molding the magnetic sheets to form the second region adjacent to the outer surface.

10. The method of claim 6, wherein the core part around which the coil is disposed is formed by disposing a plurality of coils around a cylindrical structure core part and then cutting each coil.

11. The method of claim 10, wherein the coil electronic component is manufactured by disposing the plurality of coils around the cylindrical structure, compressing magnetic metal sheets on and beneath the cylindrical structure around which the plurality of coils are loaded, and then cutting the cylindrical structure on and beneath which the magnetic metal sheets are compressed.

12. The method of claim 6, wherein the magnetic metal material included in the core part has a saturation magnetic flux larger than that of the magnetic metal material of the first region adjacent to the coil.

13. The method of claim 6, wherein the resin is a crystalline epoxy resin.

14. The method of claim 6, wherein the magnetic metal material included in the core part is a metal containing a crystalline iron (Fe)-silicon (Si) based material, or an alloy thereof.

15. A method of manufacturing a coil electronic component, comprising:
forming a magnetic body enclosing a core part around which a coil is wound using magnetic material containing magnetic metal material,
wherein the magnetic body has a first region adjacent to the coil and a second region adjacent to an outer surface of the magnetic body, and magnetic metal material of the first region adjacent to the coil has magnetic permeability higher than that of magnetic metal material of the second region adjacent to the outer surface of the magnetic body.

16. The method of claim 15, wherein the forming of the magnetic body comprises:
disposing the core part around which the coil is wound into a mold;
pressing first magnetic sheets for forming the first region adjacent to the coil in the magnetic body into the mold; and
pressing second magnetic sheets for forming the second region adjacent to the outer surface of the magnetic body into the mold after the pressing of the first magnetic sheets,
wherein the first magnetic sheets include a magnetic metal material having magnetic permeability higher than that of magnetic metal material of the second magnetic sheets.

17. The method of claim 16, wherein the second magnetic sheets for forming the second region adjacent to the outer surface of the magnetic body includes material having an insulation property higher than that of material contained in the first magnetic sheets used for forming the first region adjacent to the coil.

18. The method of claim 15, wherein the core part includes mixtures of magnetic metal material and resin, and the magnetic metal material included in the core part has a saturation magnetic flux larger than that of the magnetic metal material of the first region adjacent to the coil.

19. The method of claim 15, wherein the magnetic metal material included in the core part has a string shape.
